(19) United States
(12) Patent Application Publication
(10) Pub. No.: US 2016/0269962 A1
(43) Pub. Date: Sep. 15, 2016

(54) COMMUNICATION APPARATUS, METHOD FOR CONTROLLING COMMUNICATION APPARATUS, AND STORAGE MEDIUM

(71) Applicant: CANON KABUSHIKI KAISHA, Tokyo (JP)

(72) Inventor: Takumi Takahashi, Fuchu-shi (JP)

(21) Appl. No.: 15/063,313

(22) Filed: Mar. 7, 2016

(30) Foreign Application Priority Data
Mar. 10, 2015 (JP) 2015-047634

(51) Int. Cl. H04W 36/30; G06F 3/12; H04W 4/00

(52) U.S. Cl. CPC H04W 36/30; H04W 4/008; G06F 3/1238; G06F 3/1292; H04W 84/12

(57) ABSTRACT

In a communication apparatus, when the communication apparatus connects to a different communication apparatus that is different from the communication apparatus using a first communication method, a request message for requesting a connection by a second communication method is received from the different communication apparatus, and where a user operation indicating that the connection by the second communication method is permitted is detected, a communication parameter for making the connection by the second communication method is transmitted to the different communication apparatus by the first communication method, and where a user operation indicating that the connection by the second communication method is permitted is not detected, the connection to the different communication apparatus by the second communication method is not made.

### BACKGROUND

1. Field

Aspects of the present invention generally relate to a communication technique.

2. Description of the Related Art

Conventionally, a mobile terminal capable of using proximity wireless communication such as near field communication (NFC), Infrared Data Association (IrDA), or TransferJet® is known. In proximity wireless communication, an operation of bringing apparatuses close to each other is merely performed, thereby enabling the apparatuses to transmit and receive data to and from each other (Japanese Patent Application Laid-Open No. 2007-221355). Further, there is a technique for performing a handover from such proximity wireless communication to a different wireless communication method such as a wireless local area network (LAN) (the Institute of Electrical and Electronics Engineers (IEEE) 802.11 series) or Bluetooth®. Herein, a “handover” refers to the act of switching from communication by a first communication method to communication by a second communication method.

As described above, using proximity wireless communication such as NFC, it is possible to perform desired communication, such as performing a handover to a faster wireless communication method such as a wireless LAN, by a simple operation of bringing apparatuses close to each other. However, at the same time, such convenience also leads to the following security problem. In proximity wireless communication, communication is started by merely bringing apparatuses close to each other. Thus, communication may be started between unintended apparatuses.

### SUMMARY

According to an aspect of the present invention, a communication apparatus includes a first communication unit configured to perform wireless communication, using a first communication method, with a different communication apparatus that is different from the communication apparatus, a second communication unit configured to perform wireless communication using a second communication method that has a faster communication speed than a communication speed of the first communication method or has a longer communication distance than a communication distance of the first communication method, a detection unit configured to, in a case where the first communication unit receives a request message from the different communication apparatus for requesting a connection by the second communication unit, detect a user operation indicating that the connection by the second communication unit is permitted, and a transmission unit configured to, in a case where the detection unit detects the user operation indicating that the connection by the second communication unit is permitted, transmit from the first communication unit to the different communication apparatus a communication parameter for making a connection by the second communication unit, the communication parameter including at least one of a network identifier, an encryption method, an encryption key, an authentication method, an authentication key, a passphrase, or a media access control address, wherein in a case where the detection unit cannot detect the user operation indicating that the connection by the second communication unit is permitted, the connection to the different communication apparatus by the second communication unit is not made.

Further features of aspects of the present invention will become apparent from the following description of exemplary embodiments with reference to the attached drawings.

### BRIEF DESCRIPTION OF THE DRAWINGS

FIG. 1 is a diagram illustrating an example of a configuration of a communication system.

FIG. 2 is a diagram illustrating an example of a hardware configuration of a digital camera.

FIG. 3 is a diagram illustrating an example of a hardware configuration of a printer.

FIG. 4 is a diagram illustrating an example of a functional block configuration of the digital camera.

FIG. 5 is a diagram illustrating an example of a functional block configuration of the printer.

FIGS. 6 (6A and 6B) is a flowchart illustrating an operation of the digital camera.

FIGS. 7 (7A and 7B) is a flowchart illustrating an operation of the printer.

FIG. 8 is a diagram illustrating a communication sequence chart between the digital camera and the printer.

### DESCRIPTION OF THE EMBODIMENTS

The present disclosure discloses a communication apparatus, a method for controlling a communication apparatus, and a storage medium that are capable of improving security in a case where communication by a second communication method is performed using communication by a first communication method as a trigger.

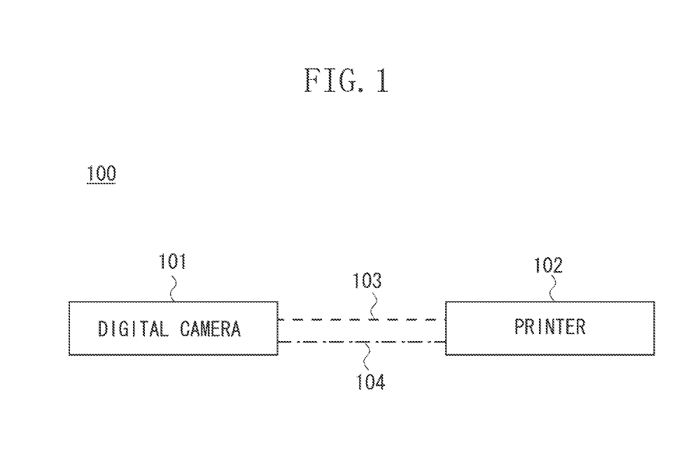

With reference to the drawings, an exemplary embodiment is described in detail below. FIG. 1 is a diagram illustrating a device configuration of a system 100 according to the present exemplary embodiment described below. The system 100 includes communication apparatuses according to the present exemplary embodiment, namely a digital camera 101 and a printer 102. A description is given using a digital camera and a printer as apparatuses in a communication system according to the present exemplary embodiment. Alternatively, for example, apparatuses such as a smartphone, a personal computer (PC), a video camera, a smartwatch, and a personal digital assistant (PDA) may be used.

The digital camera 101 and the printer 102 can communicate with each other using NFC 103, which is proximity wireless communication. In the present exemplary embodiment, in the NFC 103, the digital camera 101 and the printer 102 perform bidirectional communication in the peer-to-peer (P2P) mode defined by the NFC forum. One of the digital camera 101 and the printer 102 may communicate in the reader/writer mode defined by the NFC forum, and the other may communicate in the card emulation mode defined by the NFC forum. The reader/writer mode is a mode of reading and writing from and to a memory included in an apparatus operating in the card emulation mode. Further, the card emulation mode is a mode where an apparatus operating in the reader/writer mode reads and writes from and to a memory.

Further, the digital camera 101 and the printer 102 can communicate with each other using wireless LAN communication 104. The wireless LAN communication 104 illustrated in FIG. 1 is communication using a wireless LAN compliant with the IEEE 802.11 series. The communication form, however, is not necessarily limited to a wireless LAN compliant with IEEE 802.11. For example, the wireless LAN communication 104 may only need to use a communication method of which the communication speed is faster than that of the communication method used in the NFC 103, or the communication distance is longer than that of the communication method used in the NFC 103.

In the present exemplary embodiment, the printer 102 operates as an access point in the infrastructure mode defined by the IEEE 802.11 standard, and communicates with the digital camera 101. The access point forms a wireless network, performs an authentication/encryption process on a station, and manages a station. Further, the digital camera 101 operates as a station in the infrastructure mode defined by the IEEE 802.11 standard. Alternatively, the digital camera 101 may operate as an access point, and the printer 102 may operate as a station. Yet alternatively, the digital camera 101 and the printer 102 may perform the wireless LAN communication 104 in the ad hoc mode defined by the IEEE 802.11 standard. Yet alternatively, the communication apparatuses may perform a connection procedure with each other using Wi-Fi Direct®, to perform the wireless LAN communication 104.

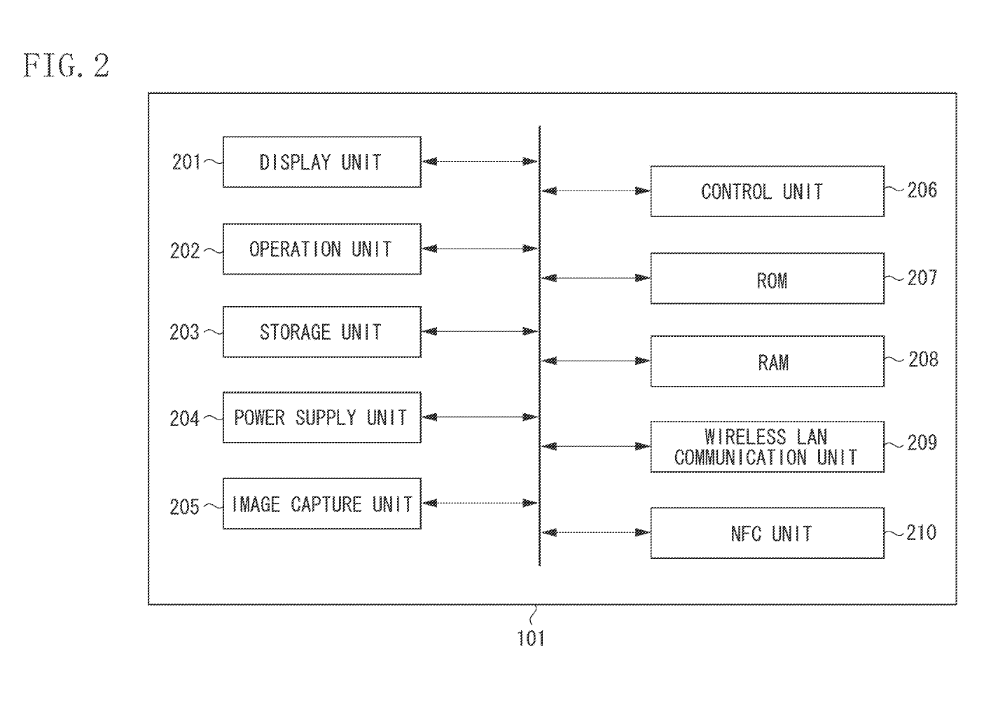

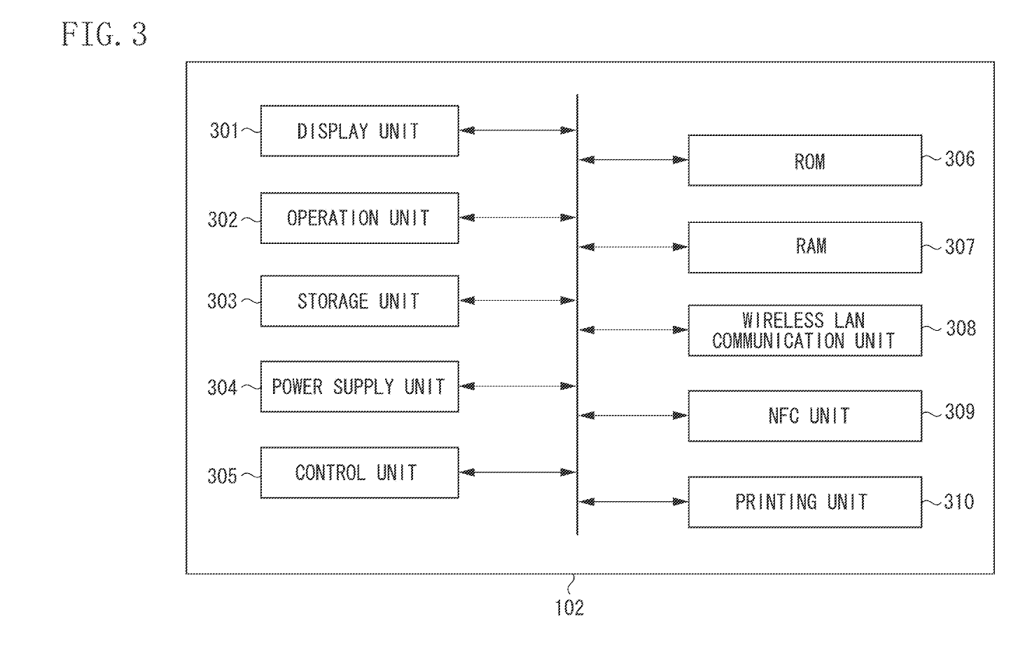

FIG. 2 is a diagram illustrating a hardware configuration of the digital camera 101. The digital camera 101 includes a display unit 201, an operation unit 202, a storage unit 203, a power supply unit 204, an image capture unit 205, a control unit 206, a read-only memory (ROM) 207, and a random-access memory (RAM) 208. Further, the digital camera 101 includes a wireless LAN communication unit 209 and an NFC unit 210.

The display unit 201 includes, for example, a liquid crystal display (LCD) or a light-emitting diode (LED), has a function of outputting information visually recognizable by a user, and controls the display of various user interfaces (UIs). The operation unit 202 has a function for the user to provide various inputs to operate the communication apparatuses. The display unit 201 and the operation unit 202 may be formed in an integrated manner using a touch panel. The storage unit 203 includes a storage medium such as a hard disk drive (HDD), a flash memory, or an attachable and detachable Secure Digital (SD) card, and stores and manages various types of data such as wireless communication network information, data transmission/reception information, and image data. The power supply unit 204 is, for example, a battery. The power supply unit 204 holds power for causing the entire apparatus to operate, and supplies power to each piece of hardware. The image capture unit 205 includes an image sensor and a lens and captures a photograph and a moving image.

The control unit 206 is, for example, a central processing unit (CPU) and controls the operation of each component of the digital camera 101. The ROM 207 stores a control command, i.e., a program. Various operations described later are implemented by the control unit 206 executing a control program stored in the ROM 207. The RAM 208 is used as a work memory and used to temporarily save data when a program is executed.

The wireless LAN communication unit 209 is a chip and an antenna for performing wireless communication compliant with the IEEE 802.11 series. In the present exemplary embodiment, it is assumed that the wireless LAN communication unit 209 performs wireless communication compliant with the IEEE 802.11 series. Alternatively, the wireless LAN communication unit 209 may use another communication method such as Bluetooth®.

The NFC unit 210 is a chip and an antenna for performing the NFC 103. The NFC unit 210 performs wireless communication compliant with the communication rule defined by the NFC forum. Further, if an apparatus capable of communicating with the digital camera 101 is detected in a communication range, the NFC unit 210 automatically establishes the NFC 103. It is assumed that the NFC unit 210 performs wireless communication compliant with the NFC standard. Alternatively, the NFC unit 210 may communicate using another type of proximity wireless communication such as IrDA or TransferJet®, or another wireless communication method. Yet alternatively, the NFC unit 210 may use the Bluetooth® low energy (BLE) method defined by Bluetooth® 4.0.

Next, with reference to FIG. 3, a hardware configuration of the printer 102 is described. The printer 102 includes a display unit 301, an operation unit 302, a storage unit 303, a power supply unit 304, a control unit 305, a ROM 306, a RAM 307, a wireless LAN communication unit 308, an NFC unit 309, and a printing unit 310. The display unit 301 includes, for example, an LCD or an LED, has a function of outputting information visually recognizable by the user, and controls the display of various UIs. The operation unit 302 has a function for the user to provide various inputs to operate the communication apparatuses. The display unit 301 and the operation unit 302 may be formed in an integrated manner using a touch panel.

The storage unit 303 includes a storage medium such as an HDD, a flash memory, or an attachable and detachable SD card, and stores and manages various types of data such as wireless communication network information, data transmission/reception information, image data, and an application. The power supply unit 304 is, for example, an alternating current (AC) power supply. The power supply unit 304 acquires, from an outlet, power for causing the entire apparatus to operate, and supplies power to each piece of hardware.

The control unit 305 is, for example, a CPU and controls the operation of the entire apparatus of the printer 102. The ROM 306 stores a control command, i.e., a program. Various operations described later are implemented by the control unit 305 executing a control program stored in the ROM 306. The RAM 307 is used as a work memory and used to temporarily save data when a program is executed.

The wireless LAN communication unit 308 is a chip and an antenna for performing the wireless LAN communication 104. The wireless LAN communication unit 308 performs wireless communication compliant with the IEEE 802.11 series. In the present exemplary embodiment, it is assumed that the wireless LAN communication unit 308 performs wireless communication compliant with the IEEE 802.11 series. Alternatively, the wireless LAN communication unit 308 may use another communication method such as Bluetooth®.

The NFC unit 309 is a chip and an antenna for performing the NFC 103 compliant with the NFC standard. Further, if an apparatus capable of communicating with the printer 102 is detected in a communication range, the NFC unit 309 automatically establishes the NFC 103. It is assumed that the NFC unit 309 performs wireless communication compliant with the NFC standard. Alternatively, the NFC unit 309 may communicate using another type of proximity wireless communication such as IrDA or TransferJet®, or another wireless communication method. Yet alternatively, the NFC unit 309 may use the BLE method. The printing unit 310 is a hardware component for performing a printing process.

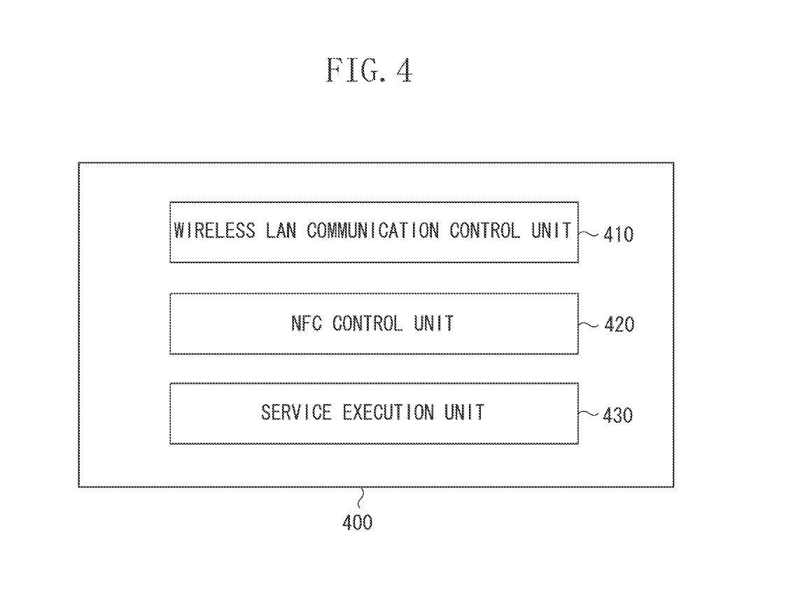

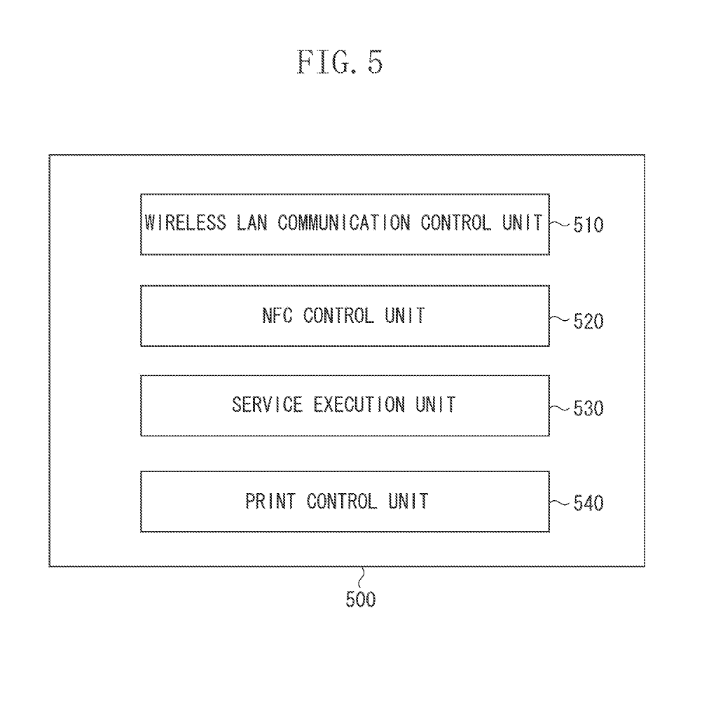

Next, with reference to FIGS. 4 and 5, functional block diagrams of the digital camera 101 and the printer 102 are described. In the present exemplary embodiment, the functional blocks of the digital camera 101 and the printer 102 are stored as programs in the ROMs 207 and 306, respectively. The functions of the digital camera 101 and the printer 102 are implemented by the control units 206 and 305 executing those programs, respectively. The control units 206 and 305 control pieces of hardware, and calculate and process information according to control programs to implement those functions. Part or all of the functional blocks may be implemented as hardware. In such a case, part or all of each functional block is configured by, for example, an application-specific integrated circuit (ASIC).

FIG. 4 is a functional block diagram (400) of the digital camera 101. The digital camera 101 includes a wireless LAN communication control unit 410, an NFC control unit 420, and a service execution unit 430.

The wireless LAN communication control unit 410 is a processing unit that controls wireless LAN communication via the wireless LAN communication unit 209. Further, the wireless LAN communication control unit 410 has a station (STA) function of operating as a station in the infrastructure mode in a wireless LAN, and an access point (AP) function of operating as an access point in the infrastructure mode in a wireless LAN. The NFC control unit 420 is a processing unit that controls NFC via the NFC unit 210. The NFC control unit 420 also has a function of detecting that the NFC 103 is established or disconnected. The NFC control unit 420 measures a predetermined period using a timer and determines the lapse of the predetermined period.

The service execution unit 430 is a processing unit that manages service information of a service that can be executed by the digital camera 101 using communication by the wireless LAN communication control unit 410, and executes the service. The service execution unit 430 manages as the service information the identifier of the service, the execution procedure of the service corresponding to the identifier, and option information of the service. The digital camera 101 can execute a data transfer service, a data reproduction service, and a print service. Further, it is assumed that the digital camera 101 can execute as the print service a “print service A” using a predetermined protocol. The print service A is executed using, for example, Point-to-Point Protocol.

FIG. 5 is a functional block diagram (500) of the printer 102. The printer 102 includes a wireless LAN communication control unit 510, an NFC control unit 520, a service control unit 530, and a print control unit 540.

The wireless LAN communication control unit 510 is a processing unit that controls wireless LAN communication via the wireless LAN communication unit 308. Further, the wireless LAN communication control unit 510 has an STA function of operating as a station in the infrastructure mode in a wireless LAN, and an AP function of operating as an access point in the infrastructure mode in a wireless LAN. The NFC control unit 520 is a processing unit that controls NFC via the NFC unit 309. The NFC control unit 520 also has a function of detecting that the NFC 103 is established or disconnected. The NFC control unit 520 measures a predetermined period using a timer and determines the lapse of the predetermined period.

The service control unit 530 is a processing unit that manages information of a service that is executed by the printer 102 via the wireless LAN communication control unit 510, and executes the service. The service control unit 530 manages as the service information the identifier of the service, the execution procedure of the service corresponding to the identifier, and option information of the service. The printer 102 can execute services that are executed using two different types of protocols, namely the “print service A” and a “print service B”. The print service B is executed using, for example, the Internet Printing Protocol. The print control unit 540 controls a printing process performed by the printing unit 310.

The operation of the communication system having the above configuration will be described below.

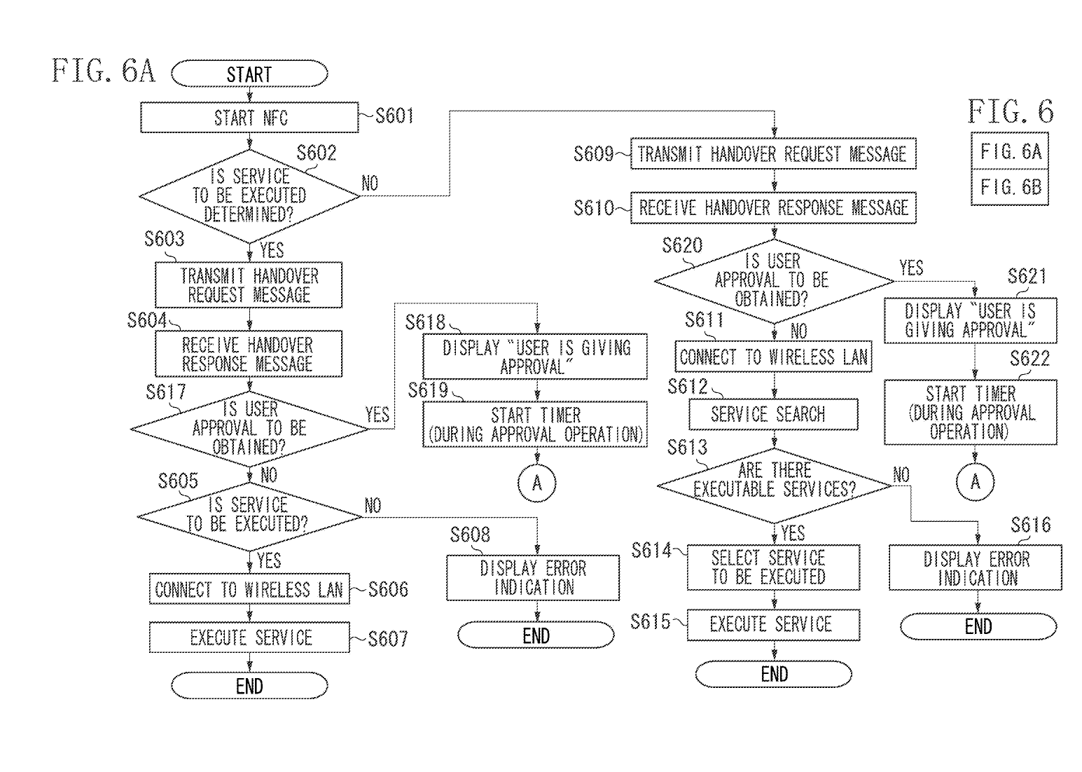

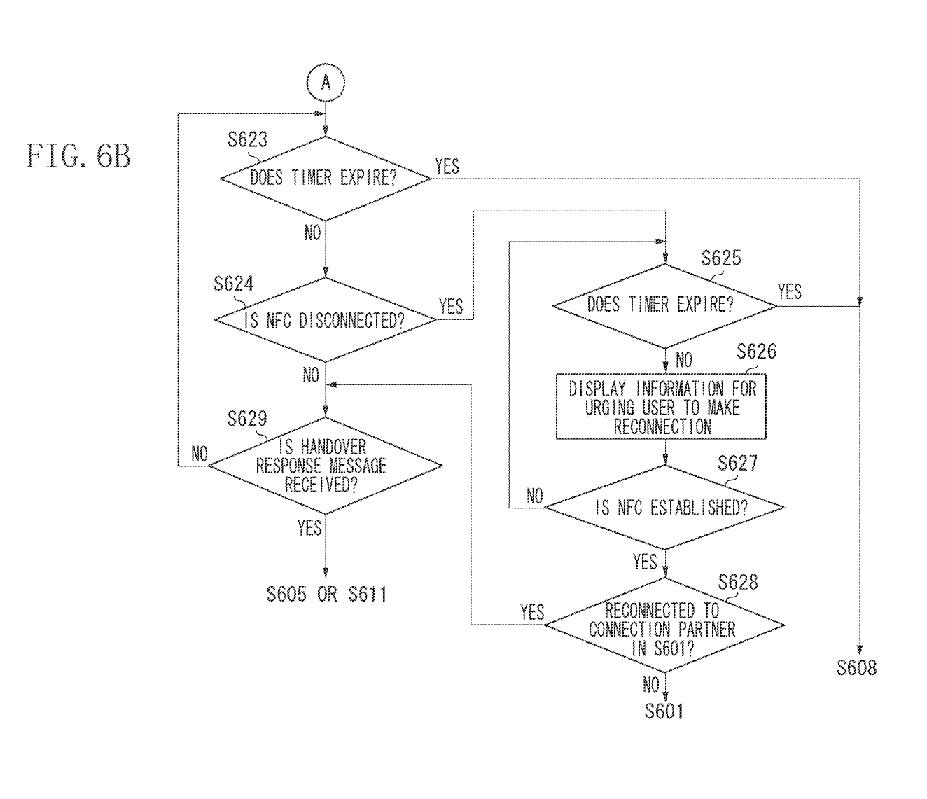

With reference to a flowchart illustrated in FIGS. (6A and 6B), the operation procedure of the digital camera 101 is described. The flowchart illustrated in FIGS. (6A and 6B) is implemented by the control unit 206 executing a control program stored in the ROM 207, calculating and processing information, and controlling each piece of hardware. The configuration may be such that some or all of the steps in the flowchart illustrated in FIGS. 6 (6A and 6B) are implemented by hardware such as an ASIC.

Further, the flowchart illustrated in FIGS. 6 (6A and 6B) is started when the digital camera 101 and the printer 102 are brought so close to each other as to perform NFC by a user operation. It is assumed that the digital camera 101 is in a state of being instructed by the user to execute a handover. If NFC is started in the state where the digital camera 101 is instructed by the user to execute a handover, the digital camera 101 transmits a handover request message. If NFC is started in a state where the digital camera 101 is not instructed by the user to execute a handover, the digital camera 101 does not transmit a handover request message, and waits for a handover request message from a partner apparatus. The digital camera 101 may transmit a handover request message in a case where the digital camera 101 is instructed by the user to execute a handover after NFC is established.

In step S601, if detecting the approach of the NFC unit 309 of the printer 102, the NFC unit 210 of the digital camera 101 establishes the NFC 103 between the digital camera 101 and the printer 102. When making a connection using the NFC 103 in step S601, the digital camera 101 exchanges identification information of the apparatuses and recognizes a connection partner. Next, in step S602, the digital camera 101 determines whether a service to be executed between the digital camera 101 and the printer 102 is determined. The determination in step S602 is made based on whether the NFC 103 is started in a state where a service to be executed is selected according to a user operation received via the operation unit 202.

For example, if the NFC 103 is started in a state where data to be processed is selected and a service corresponding to the selected data is also selected, it is determined that a service to be executed is determined.

If a service to be executed between the digital camera 101 and the printer 102 is determined (YES in step S602), then in step S603, the digital camera 101 causes the NFC unit 210 to transmit a handover request message including identifier information of the service that the printer 102 is requested to execute. The handover request message is a message for requesting a new connection using a communication method different from the NFC 103. In the present exemplary embodiment, the handover request message is a Handover Request message defined by the NFC Forum Connection Handover Technical Specification.

The handover request message transmitted in step S603 includes a record indicating carrier information. In the present exemplary embodiment, the record is an alternative carrier record defined by the NFC forum. The record includes carrier information for identifying a communication method capable of performing a handover indicated by the record, and a plurality of pieces of auxiliary information. In the present exemplary embodiment, the carrier information is information indicated by a carrier data reference defined by the NFC forum. A single piece of carrier information is stored in a single record. Information of a carrier may include the type of the carrier such as a wireless LAN, Wi-Fi Direct, or Bluetooth®, and the power state (active: an active state; or inactive: an inactive state) of each wireless carrier.

Further, in the exemplary embodiment, the auxiliary information is information indicated by an auxiliary data reference defined by the NFC forum. Identifier information of the service to be executed is stored in the auxiliary information. The identifier of the service refers to an integer value uniquely associated with a service of which the specifications are individually defined. Further, identifier information of a plurality of services can be stored in a single record. The handover request message may include additional information of the service in addition to the identifier of the service. For example, the digital camera 101 may transmit the handover request message with additional information such as the encoding format of a file to be printed, the print sheet size, the print color, or the presence or absence of two-sided printing to the handover request message.

In the present exemplary embodiment, it is assumed that the digital camera 101 determines that a print service for performing “color printing” by the “print service A” is selected as the requested service.

Next, in step S604, the digital camera 101 causes the NFC unit 210 to receive a handover response message from the printer 102 via the NFC 103 and analyzes the content of the message. If a handover response message is not received within a predetermined period (for example, within one second) after the handover request message is transmitted, the digital camera 101 may display an error indication, and the processing may end.

In the present exemplary embodiment, the handover response message is a Handover Select message defined by the NFC Forum Connection Handover Technical Specification.

The handover response message can include information indicating whether the handover using the carrier requested in the handover request message can be performed. The handover response message can also include a communication parameter required to perform wireless communication by the carrier to which the handover is to be performed. Examples of a communication parameter for establishing the wireless LAN communication 104 include a Service Set Identifier (SSID) as a network identifier, an encryption method, an encryption key, an authentication method, an authentication key, a passphrase, and a media access control (MAC) address. Further, an Internet Protocol (IP) address for performing communication on an IP layer may also be included.

If receiving the handover response message, then in step S617, the digital camera 101 determines, based on the content of the message, whether the printer 102 is to obtain user approval to perform the handover. The user approval to perform the handover is an inquiry to the user about whether to perform the handover, in order to prevent unintended access when the handover request message is received. That is, the digital camera 101 determines whether the printer 102 is to inquire of the user about whether a connection can be made using the wireless LAN 104.

The determination in step S617 may be made, for example, according to whether the handover response message includes information indicating user approval. In this case, if the handover response message includes information indicating user approval, the digital camera 101 determines that the printer 102 is to obtain user approval to perform the handover. Further, if the handover response message does not include information indicating user approval, the digital camera 101 determines that the printer 102 is not to obtain user approval to perform the handover.

Alternatively, the determination in step S617 may be made, for example, according to whether the handover response message includes carrier information. In this case, if the handover response message does not include carrier information, the digital camera 101 determines that the printer 102 is to obtain user approval to perform the handover. Further, if the handover response message includes carrier information, the digital camera 101 determines that the printer 102 is not to obtain user approval to perform the handover. Yet alternatively, the determination in step S617 may be made, for example, according to whether information included in the handover response message has a particular value.

If it is determined in step S617 that the printer 102 is to obtain user approval to perform the handover (YES in step S617), then in step S618, the digital camera 101 displays on the display unit 201 an indication that the user of the communication partner apparatus is giving approval. As an example, the digital camera 101 displays “The partner user is giving approval. Please wait for a while.” Further, if it is determined in step S617 that the printer 102 is to obtain user approval to perform the handover (YES in step S617), then in step S619, the digital camera 101 starts a timer, thereby starting to measure a predetermined period.

Then, in steps S623 and S625, if starting the timer, the digital camera 101 determines the expiration of the timer (the lapse of the predetermined period). If the timer in step S619 expires during the processing, the processing may proceed to step S608. Then, the digital camera 101 may display an error indication, and the processing may end. Then, in step S624, the digital camera 101 determines whether the NFC 103 with the printer 102 is disconnected. A case where the NFC 103 is disconnected in step S624 can be, for example, a case where the apparatuses are once separated from each other so that the communication partner apparatus obtains user approval, and an operation for approval is performed.

If the NFC 103 with the printer 102 is maintained (NO in step S624), then in step S629, the digital camera 101 determines whether a handover response message is received from the printer 102 anew. If the digital camera 101 receives a handover response message from the printer 102 anew (YES in step S629), the processing proceeds to step S605 or S611. If it is determined in step S602 that a service to be executed is determined (YES in step S602), the processing proceeds to step S605. If it is determined in step S602 that a service to be executed is not determined (NO in step S602), the processing proceeds to step S611.

If it is determined in step S624 that the NFC 103 with the printer 102 is disconnected (YES in step S624), then in step S626, the digital camera 101 displays, on the display unit 201, information for urging the user to make a reconnection. Then, in step S627, the digital camera 101 determines whether communication by the NFC unit 210 is established. If communication by the NFC unit 210 is not established in step S627 (NO in step S627), the processing returns to step S625. If, on the other hand, it is determined in step S627 that communication by the NFC unit 210 is established (YES in step S627), then in step S628, the digital camera 101 determines whether the digital camera 101 is reconnected to the connection partner in step S601. That is, the digital camera 101 determines whether the connection partner in step S601 and the connection partner in step S627 are the same. The determination in step S628 is made based on whether identification information of the connection partner in step S627 is the same as the identification information received when the NFC 103 is started in step S601.

If it is determined in step S628 that the digital camera 101 is reconnected to the connection partner in step S601 (YES in step S628), the processing proceeds to step S629. If it is not determined in step S628 that the digital camera 101 is reconnected to the connection partner in step S601 (NO in step S628), that is, if the digital camera 101 is connected to an apparatus different from the printer 102, the digital camera 101 starts the process of step S601 again. If the digital camera 101 is connected to an apparatus different from the printer 102 (NO in step S628), the digital camera 101 may display an error indication, and the processing may end.

A case is described where, on the other hand, it is determined in step S617 that the printer 102 is not to obtain user approval to perform the handover (NO in step S617). In step S605, based on the information included in the handover response message received in step S604, the digital camera 101 performs the handover to the wireless LAN communication 104 and determines whether the service using the wireless LAN communication 104 is to be executed. The handover response message received in step S604 includes information regarding whether the handover and the service requested by the handover request message transmitted in step S603 can be executed.

If it is determined in step S605 that the service is to be executed (YES in step S605), the digital camera 101 performs the process of connecting to the printer 102 using the communication method corresponding to the carrier information associated with the service to be executed according to the determination. In step S606, the digital camera 101 connects to a network of the communication method after the handover, according to the communication parameter included in the received response message. This communication parameter is information for connecting to a network constructed by the printer 102 as an access point.

If the digital camera 101 causes the wireless LAN communication unit 209 to connect to the wireless LAN 104 based on the acquired connection parameter, then in step S607, the service execution unit 430 executes the service. The service execution unit 430 executes the service using communication by the wireless LAN communication unit 209 via the wireless LAN 104 indicated by the acquired connection parameter. In the present exemplary embodiment, the service execution unit 430 executes the print service A. In the print service A, the digital camera 101 causes the wireless LAN communication unit 209 to transmit image data captured by the image capture unit 205 and stored in the storage unit 203 to the printer 102, and then causes the printer 102 to print the transmitted image data.

Further, if it is determined that the handover or the service cannot be executed based on the handover response message (NO in step S605), then in step S608, the digital camera 101 displays an error message on the display unit 201. Then, the processing ends. The notification method of an error is not limited to the display of a message. Alternatively, the notification of an error may be given by, for example, the vibration of the main body of the digital camera 101, a sound, or the lighting of an LED light.

Next, a case is described where a service to be executed between the digital camera 101 and the printer 102 is not determined in step S602 (NO in step S602). If the digital camera 101 connects to the printer 102 using the NFC 103 in the state where a service to be executed is not selected (NO in step S602), then in step S609, the NFC unit 210 transmits a request message not including service information to the printer 102 via the NFC 103. Next, in step S610, the digital camera 101 causes the NFC unit 210 to receive a handover response message from the printer 102.

In step S620, similarly to step S617, the digital camera 101 determines, based on the content of the received handover response message, whether the printer 102 is to obtain user approval to perform the handover. If it is determined in step S620 that the printer 102 is to obtain user approval to perform the handover (YES in step S620), then in step S621, the digital camera 101 displays on the display unit 201 an indication that the user of the communication partner apparatus is giving approval. As an example, the digital camera 101 displays “The partner user is giving approval. Please wait for a while.” Further, if it is determined in step S620 that the printer 102 is to obtain user approval to perform the handover (YES in step S620), then in step S622, the digital camera 101 starts a timer, thereby starting to measure a predetermined period. Then, the digital camera 101 performs the processes of step S623 and thereafter.

A case is described where, on the other hand, it is determined in step S620 that the printer 102 is not to obtain user approval to perform the handover (NO in step S620). In step S611, the digital camera 101 connects to the wireless LAN 104 according to the communication parameter included in the handover response message received in step S610. If the connection to the wireless LAN 104 is completed, then in step S612, the digital camera 101 performs a service search process on the wireless LAN 104 and collects information of services supported by the printer 102 on the network. This service search process is performed using a communication protocol such as the Simple Service Discovery Protocol (SSDP) or the multicast Domain Name System (mDNS). If, as a result of the search process in step S612, the digital camera 101 finds that the printer 102 supports services executable by the digital camera 101 (YES in step S613), then in step S614, the service execution unit 430 performs the process of selecting a service to be executed. Then, in step S615, the service execution unit 430 executes the selected service. The selection process in step S614 is performed by, for example, the user selecting a service name. If, as a result of the search process in step S612, the digital camera 101 does not find an executable service (NO in step S613), then in step S616, the service execution unit 430 displays information indicating an error on the display unit 201. Then, the processing ends. Similarly to step S608, the notification method of an error is not limited to the display of a message. Alternatively, the notification of an error may be given by, for example, the vibration of the main body of the digital camera 101, a sound, or the lighting of an LED light.

As described above, if a handover response message does not include information indicating user approval, the digital camera 101 determines, based on the received handover response message, whether the handover can be executed. If, on the other hand, a handover response message includes information indicating user approval, the digital camera 101 can determine, not based on the received handover response message but based on a response message received after that, whether the handover can be executed. That is, if a handover response message includes information indicating user approval, the digital camera 101 can delay the determination of whether the handover can be executed. In other words, the information indicating user approval can also be said to be information for giving an instruction to delay the timing for determining whether the handover can be executed. Thus, according to the presence or absence of information indicating user approval, the digital camera 101 can switch the timing for determining whether the handover can be executed. Then, even if the printer 102 obtains user approval, the digital camera 101 does not cause a malfunction such as a timeout error.

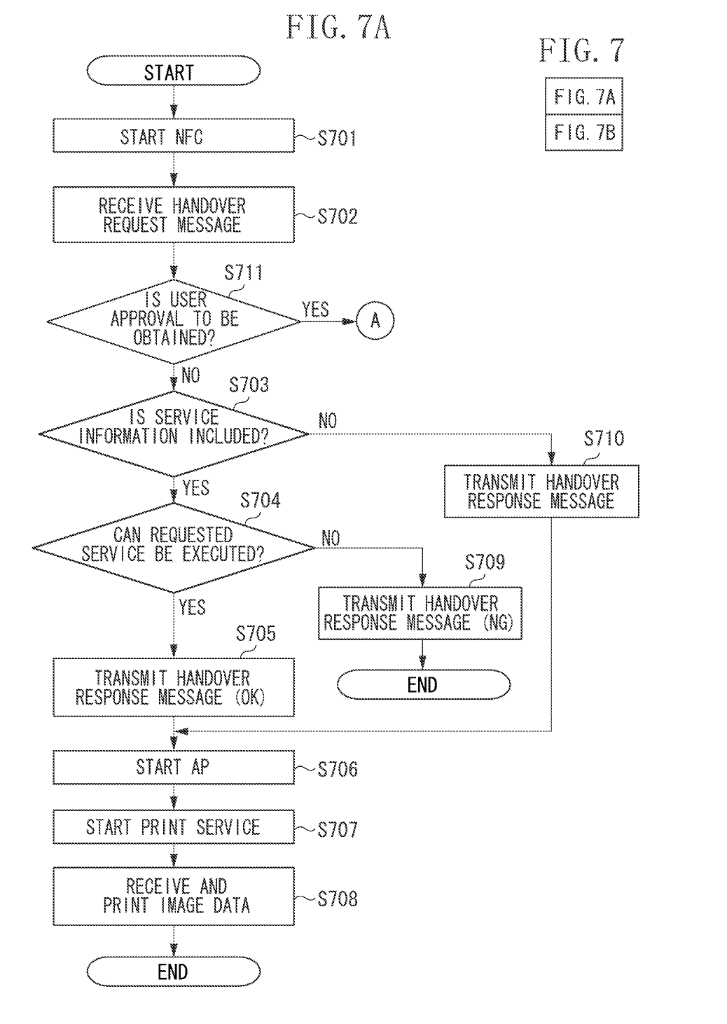

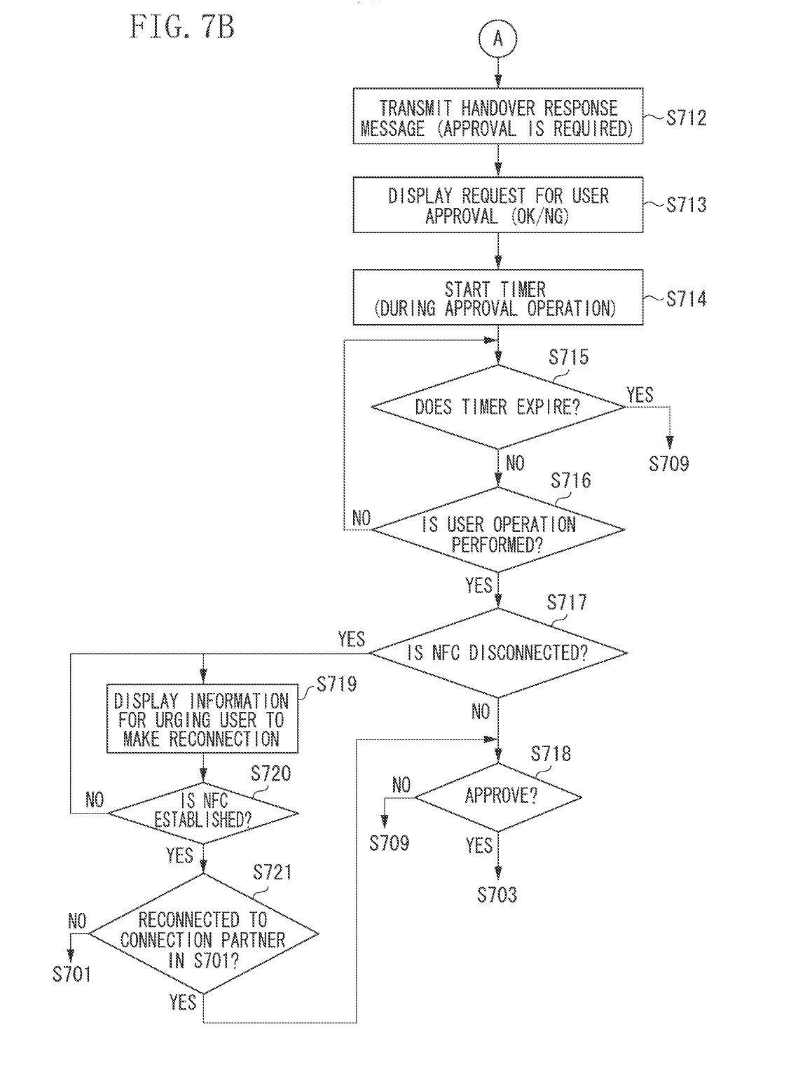

Next, with reference to a flowchart illustrated in FIGS. 7 (7A and 7B), the operation procedure of the printer 102 is described. The flowchart illustrated in FIGS. (7A and 7B) is implemented by the control unit 305 executing a control program stored in the ROM 306, calculating and processing information, and controlling each piece of hardware. The configuration may be such that some or all of the steps in the flowchart illustrated in FIGS. 7 (7A and 7B) are implemented by hardware such as an ASIC.

Further, the flowchart illustrated in FIGS. 7 (7A and 7B) is started when the digital camera 101 and the printer 102 are brought so close to each other as to perform NFC by a user operation. Further, if NFC is started in a state where the printer 102 is not instructed by the user to execute a handover, the printer 102 does not transmit a handover request message, and waits for a handover request message from a partner apparatus. It is assumed that the digital camera 101 is in a state of being instructed by the user to execute a handover. The printer 102 may transmit a handover request message if NFC is started in the state where the digital camera 101 is instructed by the user to execute a handover.

In step S701, if detecting the approach of the NFC unit 210 of the digital camera 101, the printer 102 causes the NFC unit 309 to establish the NFC 103 between the printer 102 and the digital camera 101. Next, in step S702, the printer 102 receives a handover request message from the camera 101 via the NFC 103. If receiving the handover request message, then in step S711, the printer 102 determines whether the printer 102 is to obtain user approval. The determination in step S711 is made based on whether a setting is made by the user so that the printer 102 is to obtain user approval when a handover is performed. If receiving the handover request message in the state of being set by the user via the operation unit 302 to the mode of obtaining user approval, the printer 102 determines that the printer 102 is to obtain user approval. If, on the other hand, receiving the handover request message in the state of not being set by the user via the operation unit 302 to the mode of obtaining user approval, the printer 102 determines that the printer 102 is not to obtain user approval.

Alternatively, the configuration may be such that the determination in step S711 is made according to the partner apparatus in the NFC 103. For example, if the partner apparatus in the NFC 103 is an apparatus to which the printer 102 has connected using the wireless LAN 104 in the past, the printer 102 may not attempt to obtain approval. If the partner apparatus in the NFC 103 is an apparatus to which the printer 102 has never connected using the wireless LAN 104, the printer 102 may attempt to obtain approval. Further, if the partner apparatus in the NFC 103 is an apparatus for which the printer 102 has attempted to obtain approval in the past and which has been approved, the printer 102 may omit to obtain approval. Further, the partner apparatus in the NFC 103 is an apparatus for which the printer 102 has attempted to obtain approval in the past and which has not been approved, the printer 102 may attempt to obtain approval again. Alternatively, if the partner apparatus in the NFC 103 is an apparatus for which the printer 102 has attempted to obtain approval in the past and which has not been approved, the printer 102 may not attempt to obtain approval again, and may transmit a handover response message for refusing a connection.

If it is determined in step S711 that the printer 102 is to obtain user approval (YES in step S711), the NFC unit 309 transmits a handover response message including information indicating user approval. The printer 102 transmits a handover response message including information indicating user approval, thereby notifying the digital camera 101 that the printer 102 is to inquire of the user about whether a connection can be made using the wireless LAN 104. The handover standard of the NFC forum defines that a handover response message is returned within one second after a handover request message is received. In the present exemplary embodiment, a handover response message including information indicating user approval is transmitted. Thus, it is possible to return a handover response message within one second after a handover request message is received. This prevents a timeout error even if user approval is obtained. Further, in the present exemplary embodiment, a handover response message including information indicating user approval is transmitted. This enables an apparatus to notify a communication partner apparatus of the state of the apparatus itself. This can prevent the communication partner apparatus from causing a malfunction.

Next, if transmitting the handover response message, then in step S713, the printer 102 displays on the display unit 301 a message for urging the user to give approval. As an example, in step S713, the printer 102 displays a message such as “Do you execute a handover with the NFC partner apparatus? Please touch OK or NG.”

Further, if the printer 102 is to obtain user approval to perform the handover (YES in step S711), then in step S714, the printer 102 starts a timer, thereby starting to measure a predetermined period. If starting the timer, then in step S715, the printer 102 determines the expiration of the timer (the lapse of the predetermined period). Then, in step S716, the printer 102 determines whether the operation unit 302 detects a user operation indicating approval regarding whether to execute the handover. If it is determined in step S716 that a user operation is performed (YES in step S716), then in step S717, the printer 102 determines whether the NFC 103 with the digital camera 101 is disconnected. If the NFC 103 between the printer 102 and the digital camera 101 is maintained (NO in step S717), then in step S718, the printer 102 determines whether the user operation detected in step S716 is an operation for approving the handover. That is, the printer 102 determines whether the user performs the operation of permitting a connection using wireless LAN communication. If the user operation detected in step S716 is an operation for approving the handover (YES in step S716), the processing proceeds to step S703. If the user operation detected in step S716 is an operation for not approving the handover (NO in step S716), the processing proceeds to step S709.

It is assumed that in step S713, display for urging the user to give approval regarding whether to execute the handover is performed. Alternatively, for example, if the handover request message received in step S702 includes service information of a service of which the execution is requested by the communication partner apparatus, display for inquiring whether this service can be executed or display for selecting a service to be executed may be performed.

As an example of the display for inquiring whether the service can be executed, the printer 102 displays a message such as “The digital camera is requesting the execution of a print service. Do you execute the print service?” Then, in step S716, the printer 102 determines whether the operation unit 302 detects a user operation indicating whether the requested service can be executed.

Further, if the handover request message received in step S702 includes a plurality of pieces of service information of services of which the execution is requested by the communication partner apparatus, display for selecting a service to be executed may be performed.

As described above, a handover response message including information indicating user approval is transmitted. Thus, it is possible to return a handover response message within one second after a handover request message is received. Thus, an apparatus for transmitting the response message can cause the user to select whether a service can be executed.

Next, a case is described where it is determined in step S717 that the NFC 103 with the digital camera 101 is disconnected (YES in step S717). If the NFC 103 between the printer 102 and the digital camera 101 is disconnected (YES in step S717), then in step S719, the printer 102 displays, on the display unit 301, information for urging the user to make a reconnection. Then, in step S720, the printer 102 determines whether communication by the NFC unit 309 is established. In step S720, if the timer started in step S714 expires in the state where communication by the NFC unit 309 is not established, the printer 102 may display an error indication, and the processing may end.

If it is determined in step S720 that communication by the NFC unit 309 is established (YES in step S720), then in step S721, the printer 102 determines whether the printer 102 is reconnected to the connection partner in step S701. That is, the printer 102 determines whether the connection partner in step S701 and the connection partner in step S720 are the same. The determination in step S721 is made based on whether identification information of the connection partner in step S720 is the same as the identification information received when the NFC 103 is started in step S701.

If it is determined in step S721 that the printer 102 is reconnected to the connection partner in step S701 (YES in step S721), the processing proceeds to step S718. If it is not determined in step S721 that the printer 102 is reconnected to the connection partner in step S701 (NO in step S721), that is, if the printer 102 is connected to an apparatus different from the digital camera 101, the printer 102 starts the process of step S701 again. If the printer 102 is connected to an apparatus different from the digital camera 101, the printer 102 may display an error indication, and the processing may end. Next, a case is described where it is determined in step S711 that the printer 102 is not to obtain user approval (NO in step S711). In step S703, the printer 102 determines whether the received handover request message includes service information. If the handover request message includes service information (YES in step S703), then in step S704, the printer 102 determines, with respect to each piece of service information, whether the printer 102 can execute a service indicated by the service information. If the service can be executed (YES in step S704), then in step S705, the printer 102 transmits a handover response message to the digital camera 101 by adding, to the handover response message, information indicating that the service can be executed.

Further, if all the requested services cannot be executed (NO in step S704), then in step S709, the printer 102 transmits a handover response message to the digital camera 101 by adding, to the handover response message, information indicating that the requested services cannot be executed. Further, if the requested handover is not to be executed, the printer 102 transmits a handover response message to the digital camera 101 by adding, to the handover response message, information indicating that the requested handover is not to be executed. Then, the processing ends.

Further, if the handover request message received in step S702 does not include information of a service (NO in step S703), then in step S710, the printer 102 transmits to the digital camera 101 a handover response message not including information regarding whether a service can be executed. Further, the printer 102 transmits a handover response message in steps S705 and S710 by including a communication parameter for the communication method after the handover, which is used when the service is executed. Further, in step S709, a communication parameter for connecting to the printer 102 is not added to the handover response message to be transmitted. As described above, user approval regarding whether to execute a handover with a partner connected using proximity wireless communication is obtained. Thus, a communication parameter for connecting to the apparatus itself is not provided for an unintended partner. This can improve security.

Next, after transmitting the handover response message including the communication parameter, then in step S706, the printer 102 causes the wireless LAN communication control unit 510 to start the access point function. Then, the printer 102 generates, using the access point function, a wireless LAN corresponding to the communication parameter provided for the communication partner apparatus. Further, in step S707, the printer 102 starts waiting for a print service supported by the printer 102 itself. If information of a print service is specified in the handover request message received in step S702, the printer 102 starts waiting for the specified print service. If information of a print service is not specified in the handover request message received in step S702, the printer 102 starts the process of waiting for all print services supported by the printer 102 itself. The notification of information of a service for which the waiting is started is given in the wireless LAN generated in step S706, so that a different communication apparatus in the wireless LAN searches for the information. Then, in step S708, if image data is transmitted from the digital camera 101, the printer 102 receives and prints the transmitted image data.

As described above, a handover response message includes information indicating user approval. Thus, the printer 102 can allow the digital camera 101 to delay the determination of whether the handover can be executed. In other words, the information indicating user approval can also be said to be information for giving an instruction to delay the timing for determining whether the handover can be executed. As described above, using the information indicating user approval, the printer 102 can create time for inquiring of the user about whether the handover can be executed, and also notify the digital camera 101 that the printer 102 is to inquire of the user about whether the handover can be executed. Thus, the printer 102 can inquire of the user about whether the digital camera 101 is a proper communication partner. This improves security. Further, if performing the handover with the digital camera 101 after user approval is obtained, the printer 102 can reduce the occurrence of an error in the digital camera 101 such as a timeout error. Further, even if the printer 102 receives a handover request message via NFC, but if the printer 102 cannot detect a user operation indicating that a connection using a wireless LAN is permitted, the printer 102 does not execute a handover with the connection partner in the NFC. This improves security.

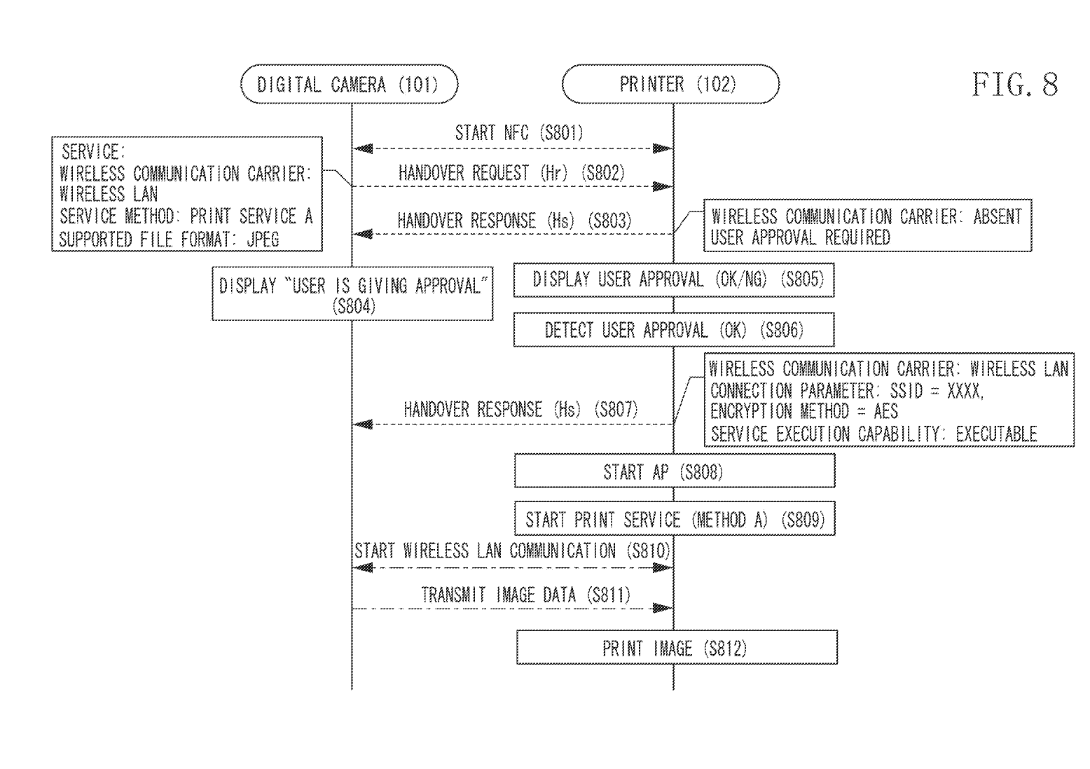

Next, with reference to FIG. 8, an example of the communication sequence between the digital camera 101 and the printer 102 is described in detail. In the example of FIG. 8, a description is given of an example of a case where the printer 102 obtains user approval for a handover. First, in step S801, the digital camera 101 and the printer 102 are brought close to each other, thereby establishing NFC between the digital camera 101 and the printer 102. Next, in step S802, the digital camera 101 transmits a handover request message to the printer 102. To this handover request message, information indicating that the digital camera 101 is to print a Joint Photographic Experts Group (JPEG) file by the “print service A”, “color printing”, and wireless LAN communication is added.

Receiving the handover request message, then in step S803, the printer 102 transmits to the digital camera 101 a handover response message not including carrier information because the printer 102 is to obtain user approval, but including information indicating that the printer 102 is to obtain user approval. Since the received handover response message includes the information indicating that user approval is required, the digital camera 101 determines that user approval is required in the printer 102. Then, the digital camera 101 displays “The user is giving approval.” on the display unit 201. Further, in step S805, the printer 102 displays on the display unit 301 a message for urging the user to give approval, and simultaneously starts a timer for a timeout error. The printer 102 may display, on the display unit 301, identification information of the digital camera 101 and the service requested by the digital camera 101 together, thereby causing the user to give approval.

Next, in step S806, before the timer expires, the printer 102 detects an operation of the user indicating approval for the handover. Then, in step S807, the printer 102 transmits to the digital camera 101 a handover response message indicating that the service requested by the digital camera 101 can be executed, and including a communication parameter for a wireless LAN to be generated by the printer 102. Next, in step S808, the printer 102 starts the access point function and generates the wireless LAN corresponding to the communication parameter transmitted in step S807. Further, in step S809, the printer 102 starts the process of waiting for a print service by the “print service A”.

On the other hand, in step S810, the digital camera 101 searches for the wireless LAN formed by the printer 102 based on the communication parameter included in the handover response message, and connects to the wireless LAN. If the connection to the wireless LAN formed by the printer 102 is completed, then in step S811, the digital camera 101 causes the wireless LAN communication unit 209 to transmit, to the printer 102, image data to be printed according to the procedure of the print service A. In step S812, the printer 102 prints the received image data.

As described above, according to the present exemplary embodiment, the occurrence of a timeout error even if user approval is obtained is reduced. Further, in the present exemplary embodiment, a handover response message including information indicating user approval is transmitted. This enables an apparatus to notify a communication partner apparatus of the state of the apparatus itself. This can prevent the communication partner apparatus from causing a malfunction. Further, user approval regarding whether to execute a handover with a partner connected using proximity wireless communication is obtained. Thus, a communication parameter for connecting to the apparatus itself is not provided for an unintended partner. This can improve security. Further, even if the printer 102 receives a handover request message via NFC, but if the printer 102 cannot detect a user operation indicating that a connection using a wireless LAN is permitted, the printer 102 does not execute a handover with the connection partner in the NFC. This improves security. Thus, according to the present exemplary embodiment, it is possible to improve security while maintaining the convenience of proximity wireless communication.

Further, if, in the state of not being instructed by the user to execute a handover, the printer 102 receives a handover request message, the printer 102 does not transmit a handover response message including a communication parameter until a user operation is detected. This can improve the security of a handover.

In the above exemplary embodiment, information of a service transmitted and received between the communication apparatuses is not limited to a service regarding printing. Alternatively, for example, information regarding a service such as an image transmission service, a moving image reproduction service, or an image scanning service may be transmitted and received. Yet alternatively, a plurality of these services may be transmitted and received together.

Further, in the above exemplary embodiment, a handover response message includes information for giving a notification that user approval is to be obtained. Alternatively, the notification may be given using a message different from the handover response message.

Further, in the above exemplary embodiment, the identifier of a service transmitted and received via NFC is an integer value uniquely associated with the service. Alternatively, the identifier of the service may be text information such as the name of the service.

Further, in the above exemplary embodiment, the configuration is such that the printer 102 or the digital camera 101 operates as an access point, and the printer 102 and the digital camera 101 connect to each other. Alternatively, the configuration may be such that the printer 102 and the digital camera 101 connect as stations to a network formed by an apparatus operating as an access point and different from the printer 102 and the digital camera 101. In this case, a communication parameter included in a handover response message is a communication parameter for connecting to the network formed by the apparatus operating as an access point.

Aspects of the present invention can also be implemented by the process of supplying a program for achieving one or more functions of the above exemplary embodiment to a system or an apparatus via a network or a storage medium, and causing one or more processors of a computer of the system or the apparatus to read and execute the program. Alternatively, aspects of the present invention can also be implemented by a circuit (e.g., an ASIC) for achieving one or more functions.

According to the present exemplary embodiment, it is possible to improve security when communication by a second communication method is performed using communication by a first communication method as a trigger.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While aspects of the present invention have been described with reference to exemplary embodiments, it is to be understood that the aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2015-047634, filed Mar. 10, 2015, which is hereby incorporated by reference herein in its entirety.

What is claimed is:

1. A communication apparatus comprising:
a first communication unit configured to perform wireless communication, using a first communication method, with a different communication apparatus that is different from the communication apparatus;
a second communication unit configured to perform wireless communication using a second communication method that has a faster communication speed than a communication speed of the first communication method or has a longer communication distance than a communication distance of the first communication method;
a detection unit configured to, in a case where the first communication unit receives a request message from the different communication apparatus for requesting a connection by the second communication unit, detect a user operation indicating that the connection by the second communication unit is permitted; and
a transmission unit configured to, in a case where the detection unit detects the user operation indicating that the connection by the second communication unit is permitted, transmit from the first communication unit to the different communication apparatus a communication parameter for making a connection by the second communication unit, the communication parameter including at least one of a network identifier, an encryption method, an encryption key, an authentication method, an authentication key, a passphrase, or a media access control address,
wherein in a case where the detection unit cannot detect the user operation indicating that the connection by the second communication unit is permitted, the connection to the different communication apparatus by the second communication unit is not made.

2. The communication apparatus according to claim 1, further comprising a setting unit configured to, in the case where the first communication unit receives the request message for requesting the connection by the second communication unit from the different communication apparatus, set whether a permission to make the connection by the second communication unit is to be obtained by a user operation,
wherein in a case where, in a state where the setting unit makes a setting so that the permission to make the connection by the second communication unit is not to be obtained by a user operation, the first communication unit receives from the different communication apparatus the request message for requesting the connection by the second communication unit, the transmission unit transmits the communication parameter to the different communication apparatus without obtaining by a user operation the permission to make the connection by the second communication unit.

3. The communication apparatus according to claim 1, further comprising:
a unit configured to transmit, to the different communication apparatus, information indicating that the permission to make the connection by the second communication unit is to be obtained by a user operation; and
a measurement unit configured to measure a predetermined period after the information is transmitted,
wherein in a case where the detection unit cannot detect, within the predetermined period measured by the measurement unit, the user operation indicating that the connection by the second communication unit is permitted, the connection by the second communication unit to the different communication apparatus is not made.

4. The communication apparatus according to claim 1, wherein in a case where the request message includes information of a service to be executed while involving communication by the second communication method, the transmission unit transmits, together with the communication parameter, information regarding whether the service can be executed.

5. The communication apparatus according to claim 4, wherein in a case where the transmission unit transmits the communication parameter, the second communication unit connects to the different communication apparatus based on the communication parameter and performs communication for executing the service indicated by the information included in the request message.

6. The communication apparatus according to claim 4, wherein the service is a data transfer service, a data reproduction service, or a print service.

7. The communication apparatus according to claim 1, further comprising a formation unit configured to, in a case where the transmission unit transmits the communication parameter, form a wireless network based on the communication parameter,
wherein the second communication unit connects to the different communication apparatus in the wireless network formed by the formation unit.

8. The communication apparatus according to claim 1, further comprising an inquiry unit configured to, in the case where the first communication unit receives from the different communication apparatus the request message for requesting the connection by the second communication unit, inquire a user about whether the connection by the second communication unit is permitted,
wherein after inquiry by the inquiry unit, the detection unit detects the user operation indicating that the connection by the second communication unit is permitted.

9. The communication apparatus according to claim 8, wherein in a case where a connection to the different communication apparatus by the first communication unit is disconnected from when the inquiry unit makes the inquiry until when the detection unit detects the user operation, the transmission unit transmits the communication parameter according to the communication apparatus connecting to the different communication apparatus by the first communication unit after the disconnection.

10. The communication apparatus according to claim 8, further comprising a display control unit configured to, in a case where a connection to the different communication apparatus by the first communication unit is disconnected from when the inquiry unit makes the inquiry until when the detection unit detects the user operation, display, on a display unit, information enabling the user make the connection to the different communication apparatus by the first communication unit.

11. The communication apparatus according to claim 1, wherein the first communication unit performs communication using near field communication, TransferJet®, or Bluetooth® low energy.

12. The communication apparatus according to claim 1, wherein the second communication unit performs communication using wireless communication compliant with the Institute of Electrical and Electronics Engineers 802.11 series.

13. A method for controlling a communication apparatus including a first communication unit configured to perform wireless communication, using a first communication method, with a different communication apparatus that is different from the communication apparatus, and a second communication unit configured to perform wireless communication using a second communication method that has a faster communication speed than a communication speed of the first communication method or has a longer communication distance than a communication distance of the first communication method, the method comprising:
detecting, in a case where the first communication unit receives a request message from the different communication apparatus for requesting a connection by the second communication unit, a user operation indicating that the connection by the second communication unit is permitted; and
transmitting, in a case where the user operation indicating that the connection by the second communication unit is permitted is detected, from the first communication unit to the different communication apparatus a communication parameter for making a connection by the second communication unit, the communication parameter including at least one of a network identifier, an encryption method, an encryption key, an authentication method, an authentication key, a passphrase, or a media access control address,
wherein, in a case where the user operation indicating that the connection by the second communication unit is permitted cannot be detected, the connection to the different communication apparatus by the second communication unit is not made.

14. A storage medium storing computer executable instructions for causing a communication apparatus including a first communication unit configured to perform wireless communication, using a first communication method, with a different communication apparatus that is different from the communication apparatus, and a second communication unit configured to perform wireless communication using a second communication method that has a faster communication speed than a communication speed of the first communication method or has a longer communication distance than a communication distance of the first communication method, to execute a method, the method comprising:
detecting, in a case where the first communication unit receives a request message from the different communication apparatus for requesting a connection by the second communication unit, a user operation indicating that the connection by the second communication unit is permitted; and
transmitting, in a case where the user operation indicating that the connection by the second communication unit is permitted is detected, from the first communication unit to the different communication apparatus a communication parameter for making a connection by the second communication unit, the communication parameter including at least one of a network identifier, an encryption method, an encryption key, an authentication method, an authentication key, a passphrase, or a media access control address,
wherein, in a case where the user operation indicating that the connection by the second communication unit is permitted cannot be detected, the connection to the different communication apparatus by the second communication unit is not made.
